(19) United States
(12) Patent Application Publication
(10) Pub. No.: US 2017/0174237 A1
(43) Pub. Date: Jun. 22, 2017

(54) Adaptable Hand Truck

(71) Applicant: Larry Kintz, Gales Creek, OR (US)

(72) Inventor: Larry Kintz, Gales Creek, OR (US)

(21) Appl. No.: 14/972,542

(22) Filed: Dec. 17, 2015

(51) Int. Cl. B62B 1/00; B62B 1/12

(52) U.S. Cl. CPC B62B 1/002; B62B 1/125

(57) ABSTRACT

An adaptable hand truck that is suitable for carrying box or bulk type loads traditionally carried by single axle hand trucks on a first load platform while further being adaptable for carrying longitudinal type loads through the deployment of an extendable axle assembly that works in cooperation with a rotationally mounted second frame assembly. When extended, the extendable axle assembly provides a first longitudinal load surface. When rotated down, the second frame assembly provides a second longitudinal load surface that is supported by a pivotally mounted wheel. Thus so adapted, the hand truck is configured for carrying box type loads on a load platform, while further having the added utility of carrying longitudinal type loads on the first load surface and the second load surface.

### CROSS-REFERENCE TO RELATED APPLICATIONS

This application claims no priority under 35 U.S.C. §119(e)(1)

### STATEMENT REGARDING FEDERALLY SPONSORED RESEARCH OR DEVELOPMENT

Not Applicable

### BACKGROUND OF THE INVENTION

Technical Field

The present invention relates to hand trucks that carry box type loads, particularly to hand trucks that also adapt for transporting longitudinal loads such as plywood, lumber, pipe, and the like.

Prior Art Discussion

Hand truck technology has been around as long as the wheel. The common configuration having a fixed single axle with a wheel on each end to carry the load. The conventional hand truck is commonly configured to carry bulk loads like boxes or crates. Specialized hand trucks for hauling longitudinal loads such as lumber or plywood sheets have been available for many years but are not suitable for also carrying heavy box loads.

Hand trucks that adapt for use as a box hauler and a linier load carrier are limited in the prior art. One example of an adaptable hand truck is taught by Whinnery in U.S. Pat. No. 8,550,476. The adaption involves a change in relative orientation as between the load carrying platform and the wheeled axle allowing for longitudinal loads to be carried in narrowed spaces. The Whinnery adaption is facilitated by a frame assembly cylinder that rotates on a vertical axis such that the load can be relocated relative to the wheeled axle. The Whinnery hand truck necessarily requires a centrally located cylinder to facilitate the adaption from box to linier load carrier.

Hand trucks adaptable to carry an increased load are taught in the prior art using additional support wheels. As disclosed by Prapavat in U.S. Pat. No. 6,273,438 a rear support structure that has two connection points. A first end connected to the axle and the second end connected to the chassis for partially supporting the weight of the load on the load lifting platform when the chassis is tilted backward. Prapavat provides a rear support structure for carrying additional load capacity on the traditional hand truck load lifting platform, but does not disclose or teach any additional load platforms that would be suitable for carrying longitudinal type loads.

There is an unsatisfied need in the hand truck arts for an adaptable truck that transforms without tools from a box or bulk type carrier to a longitudinal or linier type load carrier. The present invention, as will be understood below, provides a new and unobvious solution in having a hand cart that can haul both box loads and upon adaption, longitudinal loads.

### SUMMARY OF INVENTION

The preferred embodiment of the adaptable hand truck apparatus having a first load platform suitable for carrying box type loads, further benefiting from a telescoping axle assemble and second load platform that cooperatively works with a second frame that rotates down to provide a third load platform that is supported by a pivotally mounted wheel, the second and third load platforms being suitable to for carrying linier type loads.

The primary objective of applicant's inventive hand truck is to have all the useful functions of the conventional single axle hand truck for carrying box type loads, while being adaptable to provide the utility in carrying linier type loads.

A second object is to provide a hand truck adaption as described above without tools.

A third object includes a hand truck that is adaptable as described herein that occupies the same or less space as a conventional hand truck having similar load capacity.

Other advantages and features of the invention will become apparent upon review of the description and drawings.

### BRIEF DESCRIPTION OF THE DRAWINGS

FIG. 1 is a side perspective view of the hand truck according to the present invention.

FIG. 2 is a rear perspective view of the hand truck of FIG. 1.

FIG. 3 is a perspective view of the hand truck of FIGS. 1 & 2 adapted to carry longitudinal loads.

FIG. 4 is an environmental perspective view of the hand truck of FIG. 3 adapted and carrying a longitudinal load.

Reference Table

| Reference | |
|---|---|
| number | Description |
| 10 | Hand truck |
| 12 | First frame |
| 14 | Upper end |
| 15 | Lower end |
| 18 | Second frame |
| 19 | First end |
| 20 | Second end |
| 23 | First platform |
| 29 | Angled frame members |
| 31 | Axle/First member |
| 32 | Axle/Second member |
| 32A | Extension |
| 35 | Second platform |
| 48 | Rotationally mounted |
| | wheel |
| 49 | Fender |
| 50 | Pivotally mounted wheel |
| 52 | Third platform |
| 52A | Optional support guide |
| 60 | Sheet material load |

### DETAILED DESCRIPTION

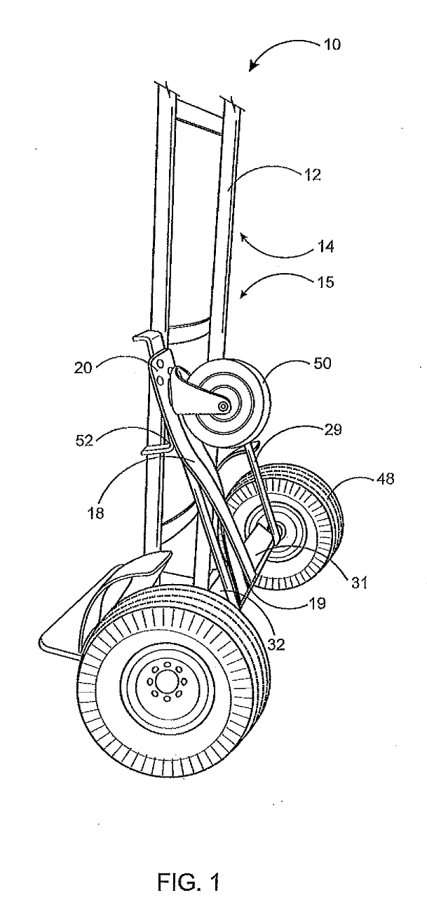

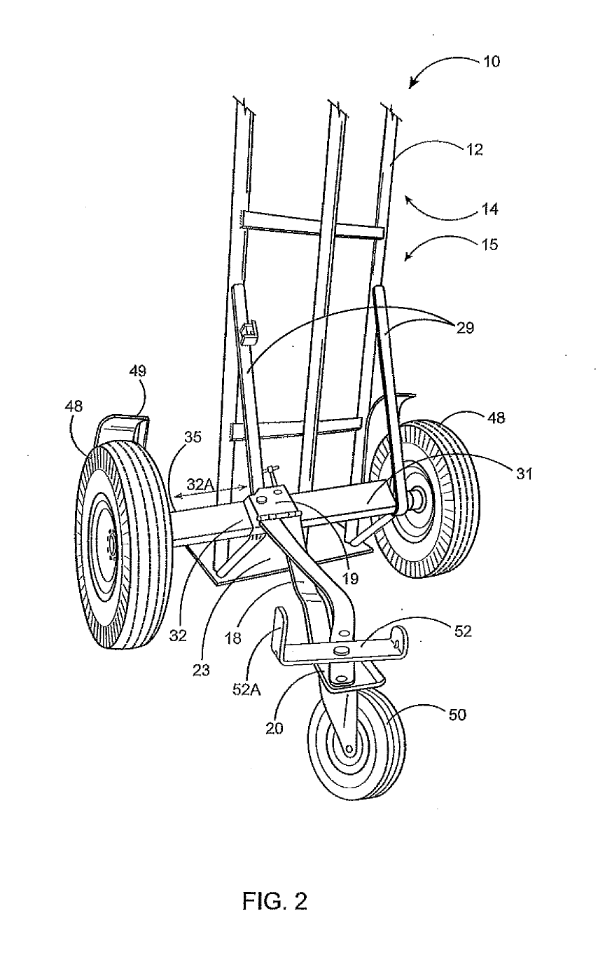

As shown in FIG. 1 in it's preferred embodiment, a hand truck 10 includes a first frame 12 having an upper end 14 that provides a handle location, and a lower end 15 that is attached to an axle assembly and a first platform 23 that cooperatively provide a traditional hand truck configuration that is suitable for carrying box type loads. What is meant by “Box Type Load” for this disclosure includes but is not limited to square and rectangular boxes, containers, and crates, also including appliances. As shown in the preferred embodiment in FIG. 1 and FIG. 2, the first platform 23 is fixedly secured to the frame's 12 lower end 15, however in other embodiments the platform 23 may be hingedly connected to pivot up and against the frame 12 to allow for more compact storage.

As shown in FIGS. 1-4, the adaptable hand truck includes the axle assembly having two angled frame members 29, a first axle member 31, and a second axle member 32. The angled frame members 29 are welded or otherwise fixated to the lower end 15 of the frame 12 on one end and to the first axle member 31 on the other. The first axle member 31 being constructed and arranged to slideably receive the second axle member 32 thereby providing a telescoping axle feature involving adapting the distance between the wheels 48. It should be noted that a linear axle assembly projecting between the wheels 48 is shown in the drawings as consists of a first axle member 31, a second axle member 32, however, the axle assembly may be formed by two spaced hub shafts oriented along the same axis, wherein at least one stub shaft is configured to extend 32A and retract in the same manner as the second axle member 32 extends 32A and retracts relative to the first axle member 31. For purposes of this disclosure, the term “axle” as described and claimed herein includes a linear axle as shown, or a pair of axle members having hubs located on the same axis.

As shown in FIG. 1 retracted and in FIG. 2 extended, the a second axle member 32 remains axially aligned with the first axle member 31, each member having a rotationally mounted wheel 48 at each outer end. The rotationally mounted wheel 48 may involve a solid wheel assembly, a wheel and pneumatic tire assembly, or a solid wheel with rubber or other elastomer coating. When the second member 32 is extended 32A relative to the first axle member 31 a second platform 35 is revealed on the top of the second member 32 to provide a platform for loading long or sheet type loads. The second platform 35 is shown smooth on the surface, however in other embodiments the surface is roughed, knurled, or rubberized to increase friction securement when holding an edge placed load.

A second frame 18 is depicted in FIG. 1 in a rotated up position configuring the hand truck for hauling box type loads. As shown in FIGS. 2, 3, and 4 the second frame 18 is rotated to the down position thereby configuring the hand truck for also hauling linier or longitudinal type loads. The second frame 18 hingedly mounts to the first member 31 on a first end 19 allowing for rotation from the up and down positions. The second frame 18 includes a pivotally mounted wheel 50 attached at a second end 20 that when rotated down provides a third platform 52 supported above the pivotally mounted wheel 50 that supports a portion of load weight placed on the third platform 52. When rotated up the pivotally mounted third wheel 50 is off the ground and located adjacent to the frame 12 out of the way, thereby allowing full function as a traditional hand truck used for carrying box type loads. When rotated down the third wheel 50 supports and stabilizes longitudinal loads as carried by the second platform 35 in cooperation with the third platform 52.

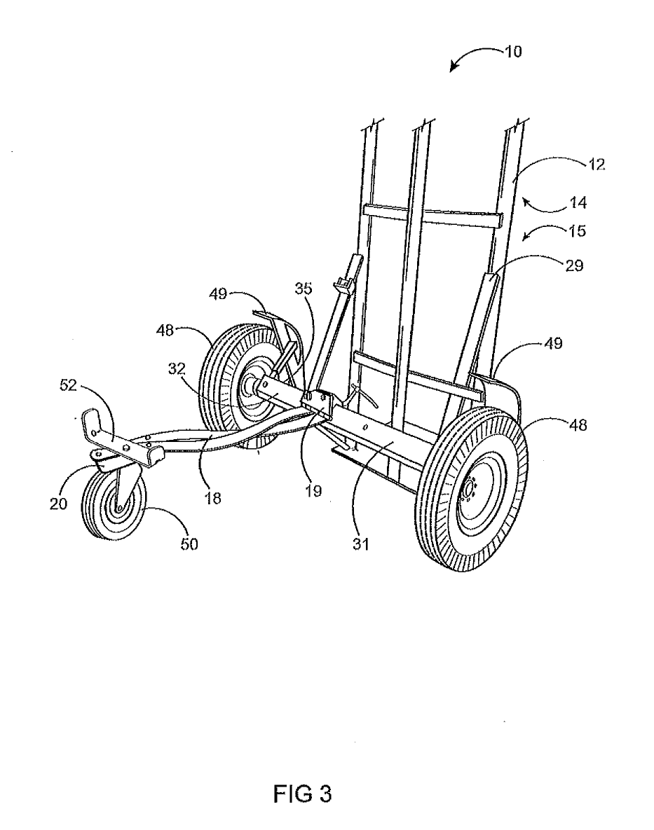

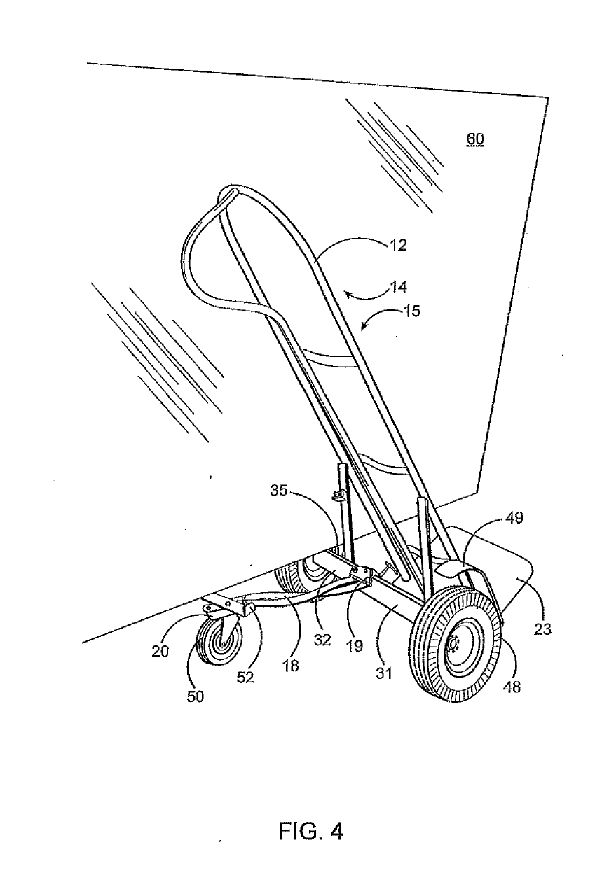

As depicted in FIG. 3 without a load, and FIG. 4 with a load of sheet material 60, the hand truck 10 is adapted for hauling longitudinal loads as carried by the second platform 35 and third platform 52. When so adapted, the second member 32 is extended out 32A, and the second frame 18 is rotated down thereby providing a lineal stabilized configuration wherein the second platform 35 and third platform 52 are suitably aligned and stabilized for cooperatively carrying long, skinny, or flat type loads. For purposes of this disclosure, the term “longitudinal type load” includes but is not limited to sheet loads such as plywood, linear loads such as lumber, and long loads like ladder or pipe.

As shown in FIGS. 1-4, the preferred embodiment includes at least one fender 49 that fixates and extends 32A out with the second axle member 32. The fender 49 being constructed and arranged to support and vertically orient, while further keeping the wheel 48 from rubbing said load. The third platform 52 is also shown with optional supports or guides 52A that locate and support longitudinal type loads.

The disclosed preferred embodiment of the present invention represents only one suitable configuration. It should be understood and noted that the invention is not limited to the provided figures and descriptions, and that various other changes or modifications may be made by one skilled in the art without departing from the scope or spirit of the invention.

I claim:

1. A hand truck adaptable for carrying longitudinal type loads, comprising:
a first frame;
a first axle member fixedly attached to a lower end of the first frame;
a first platform extending from the lower end of the first frame for carrying box type loads;
a second axle member slidably received within the first axle member, the second axle member when extended provides a second platform supported by a pair of wheels rotationally mounted on each outer end of the first axle member and the second axle member;
a second frame hingedly mounted to the first axle member on a first end, having a third wheel pivotally mounted on a second end, the second frame rotatable to ground the third wheel thereby providing a third platform supported by the third wheel that is suitably aligned with the second platform for cooperatively carrying longitudinal type loads.

2. A hand truck adaptable for carrying longitudinal type loads, comprising:
a first frame;
a first axle member fixedly attached to a lower end of the first frame;
a first platform extending from the lower end of the first frame for carrying box type loads;
a second platform supported by a pair of wheels rotationally mounted on the lower end of the first frame;
a second frame hingedly mounted to the first axle member on a first end, having a third wheel pivotally mounted on a second end, the second frame rotatable to ground the third wheel thereby providing a third platform supported by the third wheel that is suitably aligned with the second platform for cooperatively carrying longitudinal type loads.

3. The hand truck of claims 1 and 2, further including at least one fender attached to the second axle member that is constructed and arranged to prevent loads from contacting the wheel.

4. The hand truck of claims 1 and 2, further including at least one guide projecting up from the third platform.

5. The hand truck of claims 1 and 2, further including at least one angled frame members that is welded or otherwise securely fixated between the first frame and the first axle member.

6. The adaptable hand truck of claims 1 and 2, further including a friction surface on the second platform.
